(19) United States
(12) Patent Application Publication
(10) Pub. No.: US 2006/0220985 A1
(43) Pub. Date: Oct. 5, 2006

(54) Image recognition apparatus, image recognition program storage medium, and image data file

(75) Inventor: Shigeki Kawakami, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/393,705

(22) Filed: Mar. 31, 2006

(30) Foreign Application Priority Data
Mar. 31, 2005 (JP) 2005-102901

(51) Int. Cl. G09G 5/00

(52) U.S. Cl. 345/1.1

(57) ABSTRACT

There are provided an image recognition apparatus that is useful for identifying an image, an image recognition program that causes a computer to operate as the image recognition apparatus, and an image data file that is useful for identifying an image. The image recognition apparatus includes an image acquiring section that acquires image data representing a set of pixel values constituting an image; an identification data creating section that creates identification data for identifying image data by processing a set of pixel values using a predetermined algorithm; a character-string attaching section that creates character-string attached image data representing a character-string attached image in which a character string that describes identification data is aligned alongside the image; and a character-string attached image outputting section that sends character-string attached image data to an output apparatus to print the character-string attached image.

### BACKGROUND OF THE INVENTION

1. Field of the Invention

The present invention relates to an image recognition apparatus, image recognition program storage medium and image data file.

2. Description of the Related Art

Conventionally, in the field of printing a process is widely performed which generates printed material via an imaging step that acquires a captured image of an subject, an editing step that edits an image for the printed material using the captured image, and a printing step that prints the edited image. In recent years, digital cameras are being widely used in the imaging step, and accompanying the digitalization of captured images obtained in the imaging step, the processes of the subsequent editing step and printing step have also been changing.

In the conventional steps, for example, an image captured in the imaging step is recorded on film and then, in the editing step, the captured image on the film is roughly scanned by a scanner or the like and the image arrangement or the like on a page of the printed material is edited. Next, the film and data representing the edited image arrangement is passed to the printing step, where the captured image on the film is scanned at high definition and the colors of the captured image are subjected to color conversion to produce the most suitable colors for printing. Further, in the printing step, the high-definition captured image after color conversion is arranged on a page to create printed material of that page.

In contrast, in the steps following digitalization of recent years, for example, in the imaging step a captured image is recorded on a recording medium as captured image data, and in the editing step that captured image data is subjected to color conversion to create a captured image of colors matching the image of the editor. A captured image that underwent this kind of color conversion is used for editing the page and a copy of the captured image is also stored for reuse thereafter. The data for the edited page is sent to the printing step, where the colors of the captured image are again subjected to color conversion to produce the most suitable colors for printing. Thereafter the printed material is printed in accordance with the page data that contains the captured image that underwent color conversion again. As a result of this type of digitalization, there is an advantage that reutilization of a captured image is possible in the editing step (for example, see Japanese Patent Laid-Open No. 9-90599). Further, since color conversion or confirmation of colors is not essential in the editing step and are items which can be selected by an editor, it is possible that differences may arise in the intention of the editor and the printer when performing color conversion again in the printing step. Therefore, in order to avoid problems arising due to these kind of differences, it has been recommended to attach a label describing information relating to color conversion and the like to the recording medium or the like on which the page data is recorded to clearly convey the intention of the editor to process means in subsequent stages (for example, see RGB Digital Image Standardization Society, “RGB Image Operation Guidebook to prepare the final copy (camera-ready artwork) for printing,” p. 7).

However, even when a scheme has been devised to convey the intention to a subsequent step, the necessity often arises in the subsequent step to confirm whether or not the page data or captured image data that was sent is the base for the intention that has been conveyed. Further, since the actual situation is that it is necessary to rely on human labor for this kind of confirmation, quite a lot of time is spent on this kind of confirmation work at the printing site and this wastes time.

In some cases, a print obtained by printing out the page or captured image at the editing stage is attached for color confirmation to the data for a page or a captured image. However, confirmation of the correspondence between that print and the data is also necessary in the same manner as above.

There is also a case in which the file name or the like of image data is changed due to a change in the file format or the like even though the content of the image is completely the same, and in this case it is difficult to confirm the sameness of the content of the image.

### SUMMARY OF THE INVENTION

The present invention has been made in view of the above circumstances and provides an image recognition apparatus that is useful for identifying images, an image recognition program storage medium which causes a computer to operate as this type of image recognition apparatus, and an image data file that is useful in confirming the sameness of images.

An image recognition apparatus according to the present invention including:

an image acquiring section that acquires image data that represents a set of pixel values that constitute an image;

an identification data creating section that creates identification data for identifying image data that is acquired by the image acquiring section, by processing a set of pixel values represented by the image data using a predetermined algorithm;

a character-string attaching section that creates character-string attached image data which represents a character-string attached image in which a character string that describes identification data that is created by the identification data creating section is aligned alongside the image; and

a character-string attached image outputting section that sends character-string attached image data created by the character-string attaching section to an output apparatus that receives image data and prints an image based on the image data, to print the character-string attached image.

As used herein, the term “image data that represents a set of pixel values” refers to any image data that can be uniquely converted to those pixel values, regardless of the data format, and the image data may be bitmap data that directly represents that type of set of pixel values or may be compressed data in which the set of pixel values is compressed.

According to the image recognition apparatus of this invention, since a character string for identification data that identifies the pixel value set of an image is printed alongside the image, when that image was, for example, sent together with a recording medium on which the original image data is recorded, the image can easily be identified at the sending destination by preparing identification data from the image data and comparing it with the character string.

A preferable form of the image recognition apparatus according to this invention is a form in which a profile which defines a color conversion relation between a first color space according to the above pixel values and a second color space that is different from the first color space is attached to the above image data, wherein the apparatus includes:

an identification data writing section that writes identification data that is created by the identification data creating section, in the profile that is attached to image data that is acquired by the image acquiring section; and

an identified data storage section that stores, on a recording medium, image data that has identification data written in the profile attached thereto by the identification data writing section.

According to this kind of preferred form of the image recognition apparatus, since identification data is attached to image data, the image can easily be identified at the destination to which a printed image and the image data thereof were sent. Further, since the identification data is written in a profile that is attached to the image data, it is expected that deletion of the identification data can be avoided even after undergoing a change in the file format of the image data.

In the image recognition apparatus of this invention, preferably the profile is an ICC profile and is also a profile in which the identification data is described on a predetermined tag. The ICC profile advocated by the ICC (International Color Consortium) includes a tag that can be utilized for describing this kind of identification data, and since identification data is described in this tag, the identification data is maintained as it is even when the file format of image data is changed.

Preferably, in the image recognition apparatus of this invention the above identification data is an identified value that can be obtained from the set of pixel values by MD5 processing. A certified value obtained by MD5 processing is a numerical value consisting of 16 hexadecimal digits, in which a change occurs in the numerical value even if only a very small portion of the original image data was altered, and it is thus suitable for identifying an image.

The image recognition program storage medium according to this invention stores an image recognition program that is incorporated into a computer and causes the computer to include:

an image acquiring section that acquires image data that represents a set of pixel values that comprise an image;

an identification data creating section that creates identification data for identifying image data that is acquired by the image acquiring section, by processing a set of pixel values represented by the image data using a predetermined algorithm;

a character-string attaching section that creates character-string attached image data which represents a character-string attached image in which a character string that describes identification data that is created by the identification data creating section is aligned alongside the image; and

a character-string attached image outputting section that sends the character-string attached image data which is created by the character-string attaching section to an output apparatus that receives image data and prints an image based on the image data, to print the character-string attached image.

According to the image recognition program of this invention, the components that constitute the image recognition apparatus of this invention can easily be implemented by a computer.

In this connection, regarding the term “image recognition program” as used in this invention, although only the fundamental form thereof is indicated here, this is merely to avoid duplicate descriptions, and the term “image recognition program” as used in this invention includes not only the above fundamental form but also various forms corresponding to the various forms of the image recognition apparatus as described above.

Further, for the components such as an identification data creating section that the image recognition program of this invention configures on a computer, a single component may be constructed by a single program part, a single component may be constructed by multiple program parts, and multiple components may be constructed by a single program part. Further, these components may be constructed as components that themselves implement those functions, or may be constructed as components that implement those functions by instructing other programs or program parts incorporated into a computer.

The image data file according to this invention has:

an image section in which image data that represents a set of pixel values that constitute an image is stored; and

a profile section in which a profile which defines a color conversion relation between a first color space according to the pixel values and a second color space that is different from the first color space is stored, wherein the profile has identification data written therein for identifying the image data, that is created by processing a set of pixel values represented by the image data using a predetermined algorithm.

According to the image data file of this invention, since identification data is written in a profile section, an image in the image data file can easily be identified.

Further, in the image data file of this invention, preferably the profile is an ICC profile and also a profile in which the identification data is described on a predetermined tag. The ICC profile includes a tag that can be utilized for describing this kind of identification data, and since identification data is described on this tag, the identification data is maintained as it is even when the file format of image data is changed.

In the image data file of this invention, it is also preferable that the identification data is an identified value that can be obtained from the set of pixel values by MD5 processing. In an identified value obtained by MD5 processing, a change occurs in the numerical value even if only a very small portion of the original image data is altered, and it is thus suitable for identifying an image.

As described in the foregoing, the image recognition apparatus, image recognition program storage medium and image data file are useful for identifying an image.

### BRIEF DESCRIPTION OF THE DRAWINGS

FIG. 1 is a view showing an image print system to which an embodiment of this invention is applied;

FIG. 2 is a view illustrating the hardware configuration of the personal computer shown in FIG. 1;

FIG. 3 is a view showing an embodiment of the image recognition program storage medium of this invention;

FIG. 4 is a functional block diagram of an embodiment of the image recognition apparatus of this invention;

FIG. 5 is a view showing the file structure of image data in which an identified value was embedded by a data embedding section; and

FIG. 6 is a view showing a character-string attached image that was created by an information writing section.

### DETAILED DESCRIPTION OF THE INVENTION

Hereunder, an embodiment of this invention will be described referring to the attached drawings.

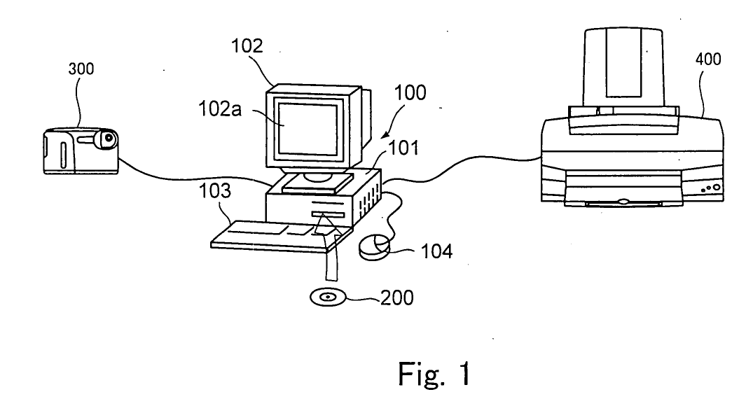

FIG. 1 is a view showing an image print system to which the embodiment of this invention is applied.

This image print system consists of a personal computer 100, a digital camera 300 and a printer 400, and is a system that is utilized at the editing step or the like. The printer 400 corresponds to one example of the output apparatus according to this invention.

Image data representing a captured image that was acquired by imaging is stored in the digital camera 300, and then is incorporated into the personal computer 100.

At the personal computer 100, color conversion of the image or page editing of printed material on which the image is disposed is performed based on the image data. In addition to being obtained from the digital camera 300, image data can also be obtained by use of a storage medium such as a CD-R (Compact Disc Recordable) or MO (magneto-optical) disc. Although various formats exist as file formats of image data, for example, a BTM file, TIFF file or JPEG file, each of these representing an image consisting of a set of pixel values. Further, in the present embodiment, a description is made on the assumption that an ICC profile is attached to the image data to constitute an integrated data file. This ICC profile represents the correlation between pixel values and colors when creating image data or when reproducing an image from the image data, and the ICC profile defines the color conversion relation between color spaces of pixel values (for example, RGB color space or CMYK color space) and color spaces that objectively represent the colors of the image (for example, Lab color space, XYZ color space or sRGB color space).

The printer 400 is controlled by the personal computer 100 to output an image.

A function that attaches, to a print image or image data, identification information for identifying the image is also incorporated into the personal computer 100 of this image print system, and this invention concerns this function.

Hereunder, the personal computer 100 will be described.

As shown in FIG. 1, the personal computer 100 consists of a main body 101 that contains a CPU, a main storage, a hard disk, a communication board and the like; a CRT display 102 that displays a screen or character string on a display screen 102a in accordance with an instruction from the main body 101; a keyboard 103 for inputting into the personal computer 100 character information or an instruction of a user; and a mouse 104 that, by designating an arbitrary position on the display screen 102a, inputs an instruction corresponding to an icon or the like displayed at that position at the time of designation.

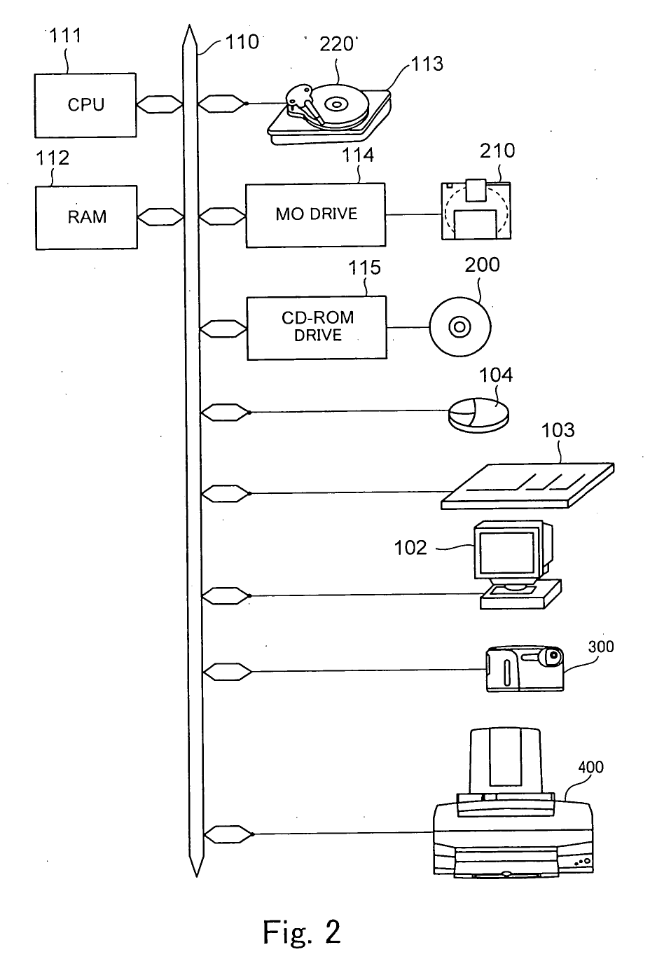

The main body 101 also contains a CD-ROM drive that loads a CD-ROM 200 or CD-R so as to be freely ejected, and reproduces information stored on the CD-ROM 200 or CD-R loaded in that manner. A magneto-optical disk (MO) 210 (not shown in FIG. 1; see FIG. 2) is loaded in the main body 101 so as to be freely ejected, and the main body 101 also contains a magneto-optical disk (MO) drive that performs recording and reproduction of information with respect to the MO 210 that was loaded in that manner.

FIG. 2 is a view illustrating the hardware configuration of the personal computer 100 shown in FIG. 1.

In this hardware configuration diagram, a CPU (central processing unit) 111, a RAM 112d, a HDD (hard disk drive) 113, an MO drive 114 and a CD-ROM drive 115 are shown, and these components are connected to each other by a bus 110.

HDD 113 contains a hard disk 220 as one kind of recording medium, and performs recording and reproduction of information with respect to the hard disk 220.

FIG. 2 also shows the mouse 104, keyboard 103, CRT display 102, digital camera 300 and printer 400 that are connected to the bus 110 through unshown I/O interfaces, respectively.

In this example, the embodiment of the image recognition program of this invention is stored on the CD-ROM 200. The CD-ROM 200 is loaded inside the main body 101, the image recognition program stored on the CD-ROM 200 is read by the CD-ROM drive 115, and installed onto the hard disk 220 via the bus 110.

When the image recognition program that was installed onto the hard disk 220 is activated, the image recognition program on the hard disk 220 is loaded onto the RAM 112 and executed by the CPU 111. When the embodiment of the image recognition program of this invention is activated and executed, the personal computer 100 operates as an embodiment of the image recognition apparatus of this invention. More specifically, in this example, the embodiment of the image recognition apparatus of this invention is constituted by the combination of the personal computer 100 and the embodiment of the image recognition program of this invention.

In this connection, a program of an editing tool that performs color conversion of an image or page editing or the like is also stored on the CD-ROM 200, and this program is also installed on the hard disk 220. When this editing tool program is activated and executed, the personal computer 100 operates as an editing tool. Since the operation of the personal computer 100 as the editing tool is not the subject of this invention, further description thereof is omitted herein.

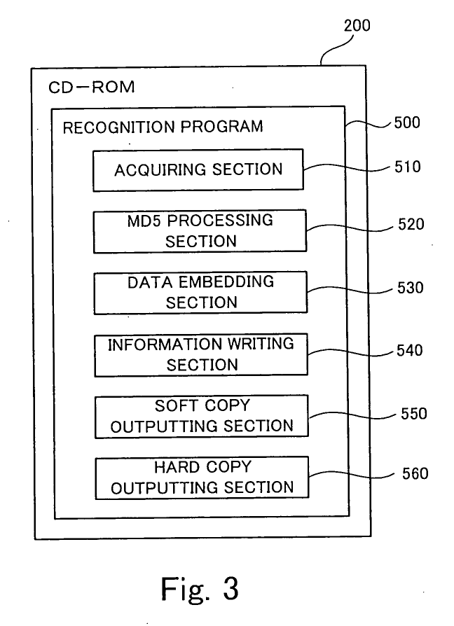

FIG. 3 is a view showing the embodiment of the image recognition program storage medium of this invention. In this example, an image recognition program 500 is stored on the CD-ROM 200 of the embodiment.

A storage medium that stores the image recognition program of this invention is not limited to CD-ROM, and may be a different kind of storage medium such as an optical disk, MO, floppy (registered trademark) disk, magnetic tape or the like. Further, the image recognition program of this invention may also be supplied directly to a personal computer through a communication network, without using a storage medium.

The image recognition program 500 is executed within the personal computer 100 shown in FIG. 1, and causes the personal computer 100 to operate as an image recognition apparatus. The image recognition program 500 has an acquiring section 510, an MD5 processing section 520, a data embedding section 530, an information writing section 540, a soft copy outputting section 550 and a hard copy outputting section 560.

Each component of the image recognition program 500 will be described in detail later.

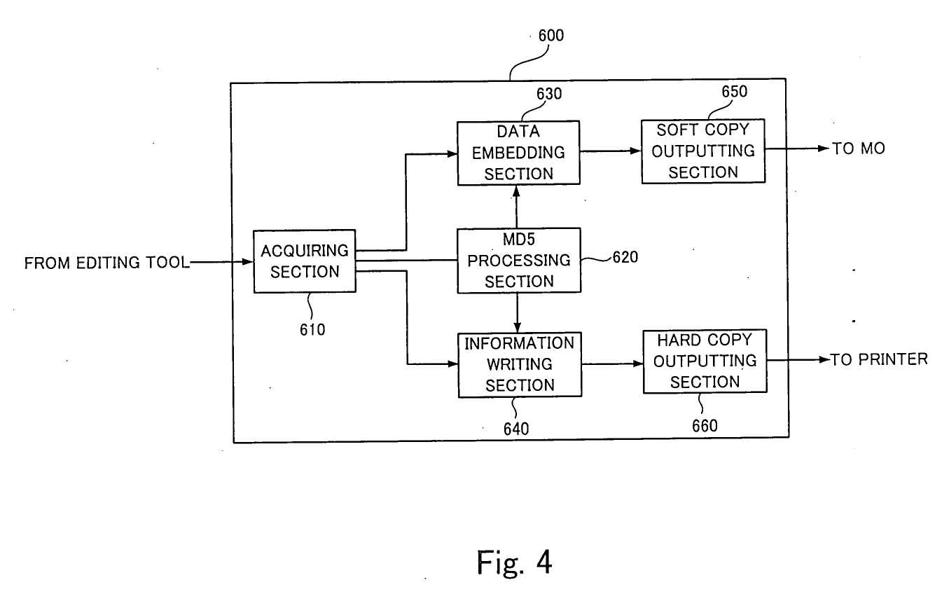

FIG. 4 is a functional block diagram of the embodiment of the image recognition apparatus of this invention.

This image recognition apparatus 600 is constituted by the image recognition program 500 of FIG. 3 being installed into the personal computer 100 shown in FIG. 1 and executed.

The image recognition apparatus 600 is composed by an acquiring section 610, an MD5 processing section 620, a data embedding section 630, an information writing section 640, a soft copy outputting section 650 and a hard copy outputting section 660. The acquiring section 610, MD5 processing section 620, data embedding section 630, information writing section 640, soft copy outputting section 650 and hard copy outputting section 660 are constituted on the personal computer 100, by the acquiring section 510, the MD5 processing section 520, the data embedding section 530, the information writing section 540, the soft copy outputting section 550 and the hard copy outputting section 560, respectively, which constitute the image recognition program 500 shown in FIG. 3. Thus, although each of the components of the image recognition apparatus 600 shown in FIG. 4 corresponds respectively to each of the components of the image recognition program 500 shown in FIG. 3, a difference between the components of FIG. 4 and the components of FIG. 3 is that, while each of the components of FIG. 4 is composed by a combination of the hardware of the personal computer 100 shown in FIG. 1 and the OS or application programs executed by the personal computer, each of the components shown in FIG. 3 is composed by only an application program among them.

The acquiring section 610, MD5 processing section 620, data embedding section 630, information writing section 640, soft copy outputting section 650 and hard copy outputting section 660 respectively correspond to one example of the image acquiring section, identification data creating section, identification data creating section, character-string attaching section, identified data storage section and character-string attached image outputting section of the image recognition apparatus of this invention.

Hereunder, by describing each component of the image recognition apparatus 600 shown in FIG. 4, each component of the image recognition program 500 will also be described at the same time.

The acquiring section 610 that constitutes the image recognition apparatus 600 of FIG. 4 acquires, from the editing tool, image data representing an image that is an object of identification which has been obtained from the digital camera 300 or the like shown in FIG. 1 and has undergone color conversion or page editing or the like.

The MD5 processing section 620 subjects the image data acquired by the acquiring section 610 to MD5 processing that performs an operation in accordance with a predetermined hash table to calculate an identified value that consists of 16 hexadecimal digits. This certified value is devised such that the value changes even if only a very small part of the original data changes, and is thus suitable to confirming the sameness of data. The data to be calculated in this case is data for the pixel value set constituting the image, and when the image data acquired by the acquiring section 610 is compressed data obtained by compressing this set of pixel values, the operation is performed for data obtained by decompressing the compressed data. Further, the data to be calculated is the data portion that purely represents an image in the image data file, and data for an ICC profile or the like attached to the image is excluded from the data to be calculated.

In the data embedding section 630, the certified value consisting of 16 hexadecimal digits that was acquired by the MD5 processing section 620 is embedded in the ICC profile that is included in the image data file.

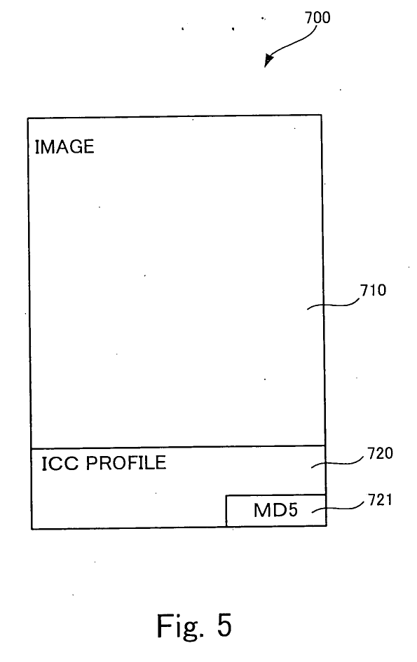

FIG. 5 is a view showing the file structure of image data in which an identified value was embedded by the data embedding section 630.

A file 700 of image data is composed by an image portion 710 in which data representing purely an image is stored, and a profile portion 720 in which an ICC profile for that image is stored. In the profile portion 720, MD5 identification data is embedded in a predetermined tag of the ICC profile. This tag is originally provided for in the ICC profile protocol, and as long as an image data file is one that assumes use of an ICC profile, the existence of this tag is guaranteed even if the file format is changed.

Image data that was embedded with an identified value in this manner by the data embedding section 630 of FIG. 4 is sent to the soft copy outputting section 650 to record that image data on a recording medium (in this embodiment, an MO).

Meanwhile, in the information writing section 640, a character string that describes an identified value consisting of 16 hexadecimal digits that were obtained by the MD5 processing section 620 is aligned alongside an image represented by the image data to create a character-string attached image.

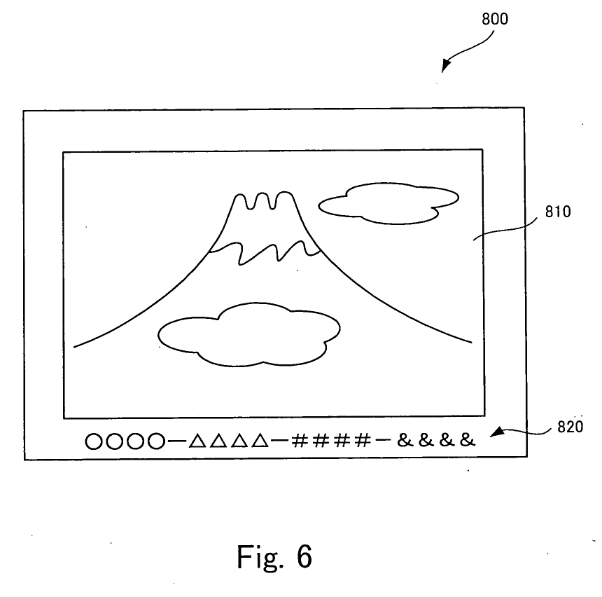

FIG. 6 is a view showing a character-string attached image that was created by the information writing section 640.

In a character-string attached image 800, an image 810 that is represented by the original image data is aligned alongside a character string 820 that describes an identified value consisting of 16 hexadecimal digits. According to this character-string attached image 800, the image data that was the source of the image 810 can be identified by the certified value represented by the character string 820.

The information writing section 640 of FIG. 4 that created this character-string attached image 800 sends the image data representing the character-string attached image 800 to the hard copy outputting section 660. Thereafter, by outputting the image data to the printer 400 shown in FIG. 1, the hard copy outputting section 660 causes the printer 400 to print the character-string attached image 800 represented by that image data.

By the operation of the image recognition apparatus 600 in this manner, at the image print system shown in FIG. 1, can obtain an MO with an image data file having the file structure as shown in FIG. 5 recorded thereon and a print of a character-string attached image having the structure shown in FIG. 6. The MO and print are sent, together or separately, to a subsequent step such as a printing step. In the subsequent step, the sameness of the image can be confirmed by comparing the certified value represented by the character string that is recorded on the print and the certified value in the image data file. In this connection, when an apparatus that performs MD5 processing is prepared in the subsequent step, an identified value that is embedded in the image data is not necessary, and the sameness can also be confirmed by an identified value that is obtained by performing MD5 processing for a set of pixel values represented by the image data.

In the foregoing description, although as the embodiment of this invention an image recognition apparatus was described that realizes both recording of an image data file onto a recording medium and printing of an image, the image recognition apparatus of this invention may be an apparatus that realizes only printing of an image.

What is claimed is:

1. An image recognition apparatus, comprising:
an image acquiring section that acquires image data that represents a set of pixel values that constitute an image;
an identification data creating section that creates identification data for identifying image data that is acquired by the image acquiring section, by processing a set of pixel values represented by the image data using a predetermined algorithm;
a character-string attaching section that creates character-string attached image data which represents a character-string attached image in which a character string that describes identification data that is created by the identification data creating section is aligned alongside the image; and
a character-string attached image outputting section that sends character-string attached image data created by the character-string attaching section to an output apparatus that receives image data and prints an image based on the image data, to print the character-string attached image.

2. The image recognition apparatus according to claim 1, wherein the image data is attached with a profile which defines a color conversion relation between a first color space according to the pixel values and a second color space that is different from the first color space, the apparatus further comprising:
an identification data writing section that writes identification data that is created by the identification data creating section, in a profile that is attached to image data that is acquired by the image acquiring section; and
an identified data storage section that stores, on a recording medium, image data having identification data written in a profile attached thereto by the identification data writing section.

3. The image recognition apparatus according to claim 2, wherein the profile is an ICC profile and also a profile in which the identification data is described on a predetermined tag.

4. The image recognition apparatus according to claim 2, wherein the identification data is an identified value that is obtained from the set of pixel values by MD5 processing.

5. An image recognition program storage medium that stores an image recognition program that is incorporated into a computer and causes the computer to comprise:
an image acquiring section that acquires image data that represents a set of pixel values that comprise an image;
an identification data creating section that creates identification data for identifying image data that is acquired by the image acquiring section, by processing a set of pixel values represented by the image data using a predetermined algorithm;
a character-string attaching section that creates character-string attached image data which represents a character-string attached image in which a character string that describes identification data that is created by the identification data creating section is aligned alongside the image; and
a character-string attached image outputting section that sends the character-string attached image data which is created by the character-string attaching section to an output apparatus that receives image data and prints an image based on the image data, to print the character-string attached image.

6. An image data file, comprising:
an image section in which image data that represents a set of pixel values that constitute an image is stored; and
a profile section in which a profile which defines a color conversion relation between a first color space according to the pixel values and a second color space that is different from the first color space is stored, wherein the profile has identification data written therein for identifying the image data, that is created by processing a set of pixel values represented by the image data using a predetermined algorithm.

7. The image data file according to claim 6, wherein the profile is an ICC profile and also a profile in which the identification data is described on a predetermined tag.

8. The image data file according to claim 6, wherein the identification data is an identified value that can be obtained from the set of pixel values by MD5 processing.
